(19) United States
(12) Patent Application Publication
(10) Pub. No.: US 2025/0053513 A1
(43) Pub. Date: Feb. 13, 2025

(54) OPPORTUNISTIC CLEANING OF COHERENCE DIRECTORIES TO REDUCE CACHE-COHERENCE OVERHEAD

(71) Applicant: Samsung Electronics Co., Ltd., Suwon-si (KR)

(72) Inventor: Samantika Subramaniam Sury, Westford, MA (US)

(21) Appl. No.: 18/432,630

(22) Filed: Feb. 5, 2024

Related U.S. Application Data
(60) Provisional application No. 63/531,384, filed on Aug. 8, 2023.

(51) Int. Cl. G06F 12/0817; G06F 12/0831

(52) U.S. Cl. CPC G06F 12/0817; G06F 12/0831; G06F 2212/304

(57) ABSTRACT

A cache-coherent computer system node includes a network-on-chip, a number of computing elements in communication with the network-on-chip, a coherence directory including a number of addresses for cache of the computing elements, a number of coherence states of the addresses, and a number of tracking vectors of the addresses, and a coherence directory controller configured to send a probe to the computing elements during a free cycle of the network-on-chip. The probe is configured to inquire whether an address of the addresses stored in the coherence directory is in the cache of the computing elements, and the coherence directory is configured clean the coherence directory to remove the address in response to an acknowledgement indicating that the address is not in the cache.

### CROSS-REFERENCE TO RELATED APPLICATION(S)

The present application claims priority to and the benefit of U.S. Provisional Application No. 63/531,384, filed Aug. 8, 2023, the entire content of which is incorporated herein by reference.

### BACKGROUND

### 1. Field

The present application relates to a system and method for cleaning the coherence directory of a computer system.

### 2. Description of the Related Art

Computer nodes include a number of computing elements, such as cores and/or accelerators, that cache data. In some cache-coherent nodes, a coherence directory is utilized that tracks all of the addresses of the cached data in the node and identifies which computing elements are caching the cached line. The coherence directory is utilized to send snoop requests to get a current copy of the data and to invalidate cached copies in response to a computing element modifying the cached data. Additionally, in some cache-coherent nodes, the computing elements update the coherence directory when they want to evict cached lines or change their state to keep the entire node up-to-date. This is done by evicting an existing line out of the directory and removing all its associated data copies from the node. In this scenario, having up to date information helps to evict lines that are old or not required to make space for new lines. In high-performance computing (HPC) applications and general data center systems with few cores, evictions cleaned the directories and kept the coherence state up to date.

However, it is becoming increasingly common for cores/accelerators to employ silent evictions which drops clean or unmodified copies of data from the caches without informing the coherence directories to avoid unnecessary core compute cycles (i.e., messages that will notify the directories) and to reduce message traffic on the network-on-chip. This leads to the coherence directories becoming stale, which can lead to inefficient evictions, unnecessary invalidate or snoop messages being sent out, and performance degradation. Furthermore, silent evictions also lead to designers having to significantly overprovision the coherence directories to account for the presence of stale lines. Without this overprovisioning and with silent evictions, all lines start to look like they are being concurrently used since the coherence directories are not getting cleaned at cache line eviction time. As the number of cores or accelerator caches increases on a node, the growth in the coherence directories (through the extra number of lines as well as increase in tracking bit vector size) can cause serious area and power concerns.

The above information disclosed in this Background section is only for enhancement of understanding of the background of the invention and therefore it may contain information that does not constitute prior art.

### SUMMARY

The present disclosure relates to various embodiments of a cache-coherent computer system node. In one embodiment, the cache-coherent computer system node includes a network-on-chip, a number of computing elements in communication with the network-on-chip, a coherence directory including a number of addresses for cache of the computing elements, a number of coherence states of the addresses, and a number of tracking vectors of the addresses, and a coherence directory controller configured to send a probe to the computing elements during a free cycle of the network-on-chip. The probe is configured to inquire whether an address of the addresses stored in the coherence directory is in the cache of the computing elements, and the coherence directory is configured clean the coherence directory to remove the address in response to an acknowledgement indicating that the address is not in the cache.

The computing elements may be homogeneous and include a number of cores.

The computing elements may be homogeneous and include a number of accelerators.

The computing elements may be heterogeneous and include a combination of cores and accelerators.

The coherence directory controller may be configured to send the probe when the computing elements are busy.

The coherence directory controller may be configured to send the probe not in response to a command from the computing elements.

The probe may be incorporated into a standard coherence protocol.

The standard coherence protocol may be a MESI protocol.

The coherence directory controller may be configured to send the probe utilizing an existing probe/snoop channel of the standard coherence protocol.

The cache-coherent computer system node may also include main memory connected to the cache.

The cache-coherent computer system node may also include an interconnect, and the coherence directory controller may be configured to send the probe over the interconnect.

The coherence directory controller may be configured to send the probe intermittently.

The present disclosure also relates to various embodiments of a method of cleaning a coherence directory in a node of a computer system that includes a network-on-chip and a number of cores and/or a number of accelerators connected to the network-on-chip. In one embodiment, the method includes sending, from a coherence directory controller, a probe to cache of the cores and/or the accelerators during a free cycle of the network-on-chip. The probe inquires whether an address stored in a coherence directory is in the cache. The method also includes receiving an acknowledgement in response to the probe, and cleaning the address from the coherence directory in response to the acknowledgement indicating that the address is not in the cache.

The cores and/or the accelerators may be busy during the sending of the probe.

The sending of the probe may not be in response to a command from the cores and/or the accelerators.

The probe may be incorporated into a standard coherence protocol.

The standard coherence protocol may be a MESI protocol.

The sending of the probe may utilize an existing probe/snoop channel of the standard coherence protocol.

The sending of the probe may include sending the probe over an interconnect.

The sending of the probe may include sending the probe intermittently.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable system or method.

### BRIEF DESCRIPTION OF THE DRAWINGS

The features and advantages of embodiments of the present disclosure will be better understood by reference to the following detailed description when considered in conjunction with the drawings. The drawings are not necessarily drawn to scale.

FIG. 1 is a schematic view of a computer system including a number of computing elements configured to utilize cache, a coherence directory listing addresses of the cache, and a network-on-chip (NOC) connected to the computing elements according to one embodiment of the present disclosure; and

FIG. 2 is a flowchart illustrating tasks of a method of cleaning a coherence directory according to one embodiment of the present disclosure.

### DETAILED DESCRIPTION

The present disclosure relates to various embodiments of a system and a method for cleaning a coherence directory of a node in a computer system that includes a network-on-chip and a number of computing elements, such as cores, accelerators, or a combination of cores and accelerators. The systems and methods of the present disclosure utilize a message (i.e., a probe) periodically sent from a coherence directory controller to the cache of the computing elements during a free cycle of the network-on-chip (NOC). In response to the message determining that an address in the coherence directory is no longer in the cache for computing elements, the coherence directory is configured to clean itself by removing the unused address. In this manner, the systems and methods of the present disclosure are configured to clean the coherence directory without involvement (e.g., requests) from the computing elements (e.g., the cores and/or the accelerators). Cleaning the coherence directory during free cycles of the NOC is useful in high-performance computing (HPC) applications where there are periods of computation where the cores or accelerator computes are busy, but the NOC is idle. During these idle periods the opportunistic cleaning can happen in the background.

Hereinafter, example embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof may not be repeated.

In the drawings, the relative sizes of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

For the purposes of this disclosure, expressions such as “at least one of,” when preceding a list of elements, modify the entire list of elements and do not modify the individual elements of the list. For example, “at least one of X, Y, and Z,” “at least one of X, Y, or Z,” and “at least one selected from the group consisting of X, Y, and Z” may be construed as X only, Y only, Z only, any combination of two or more of X, Y, and Z, such as, for instance, XYZ, XYY, YZ, and ZZ, or any variation thereof. Similarly, the expression such as “at least one of A and B” may include A, B, or A and B. As used herein, “or” generally means “and/or,” and the term “and/or” includes any and all combinations of one or more of the associated listed items. For example, the expression such as “A and/or B” may include A, B, or A and B.

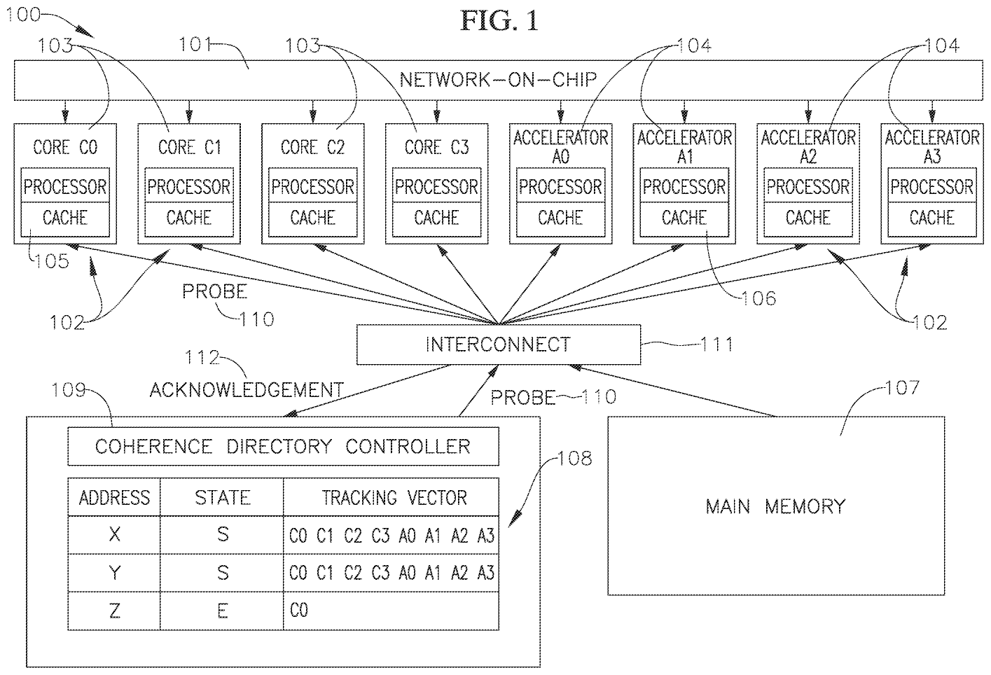

FIG. 1 is a schematic view of a node 100 of a computer system including a network-on-chip (NOC) 101 and a number of computing elements 102 connected to the NOC 101. In the illustrated embodiment, the computing elements 102 include cores 103 (e.g., cores C0, C1, C2, and C3) and accelerators 104 (e.g., accelerators A0, A1, A2, and A3). In one or more embodiments, the computing elements 102 of the node 101 may be homogeneous (e.g., cores only or accelerators only) or heterogeneous (e.g., a mixture of cores and accelerators).

In the illustrated embodiment, the computing elements 102 (e.g., the cores 103 and the accelerators 104) include cache 105, 106 (e.g., a high-speed data storage layer stored in random-access memory (RAM)), respectively, that store a subset of the blocks stored in main memory 107. Additionally, in the illustrated embodiment, the system 100 includes a coherence directory 108 that contains a list of data addresses of the cached data, a corresponding list of the coherence state of the cached data (e.g., the cached line has been modified (M) from the value in the main memory 107; the cached line matches the value in the main memory 107 and is exclusive (E) to one core or one accelerator; the cached line matches the value in the main memory 107 and is shared(S) among two or more cores and/or accelerators; or the cached line is invalid (I) according to the MESI protocol), and a list of corresponding tracking bit vectors that indicate which core(s) 103 and/or accelerator(s) 104 are caching that data address. For example, in the illustrated embodiment, the coherence directory 108 lists address “X” and address “Y” each being cached by cores C0, C1, C2, and C3 and accelerators A0, A1, A2, and A3, and having coherence state “S” because the address “X” and address “Y” are both shared among multiple C0, C1, C2, and C3 and accelerators A0, A1, A2, and A3. Additionally, in the illustrated embodiment, the coherence directory 108 lists address “Z” being cached only by core C0, and having coherence state “E” because the address “Z” is cached by only a single computing element, core C0. However, as illustrated in FIG. 1, the cache at address “Y” is not utilized by any of the computing elements 102 (e.g., the cores C0, C1, C2, and C3 or the accelerators A0, A1, A2, and A3).

In the illustrated embodiment, a coherence directory controller 109 is configured to intermittently (e.g., periodically) send a command or message 110 (e.g., a “Check_presence” probe), over an on-node interconnect 111 to the caches 105, 106 of the core(s) 103 and/or accelerator(s) 104, to determine if a particular address in the coherence directory 108 is in any of the caches 105, 106 of the core(s) 103 and/or accelerator(s) 104. Additionally, in one or more embodiments, the coherence directory controller 109 is configured to send the command 110 (e.g., the probe) during a free cycle of the NOC 101 (e.g., the coherence directory controller 109 is configured to send the command 110 when the NOC 101 is idle). In one or more embodiments, the message or command 110 (e.g., the probe) may be incorporated into any standard coherence protocol (e.g., the MSI protocol, the MESI protocol, or the MOSI protocol) and it may utilize an existing probe/snoop channel. This probe 110 looks to the core(s) 103 and/or accelerator(s) 104 like any other probe from the NOC 101.

For instance, in the illustrated embodiment, the coherence directory controller 109 is configured to send a message 110 (“Check_presence Y”) over the on-node interconnect 111 to determine whether address “Y” in the coherence directory is in any of the caches 105, 106 of the core(s) 103 and/or accelerator(s) 104. In response to an acknowledgement message 112 indicating that the address “Y” does not reside in any of the caches 105, 106 of the core(s) 103 and/or accelerator(s) 104, the coherence directory 108 is configured to delete (e.g., scrub) that address entry “Y” from the coherence directory 108. In this manner, the coherence directory 108 is configured to opportunistically clean itself in the background during idle periods of the NOC 101 without receiving a request, prompt, or other input from the core(s) 103 and/or accelerator(s) 104 (e.g., the probe 110 provides enhanced functionality of the coherence directory controller 109 so that it can initiate transactions on its own). Cleaning the coherence directory 108 without first receiving a request, prompt, or other input from the core(s) 103 and/or accelerator(s) 104 enables the core(s) 103 and/or accelerator(s) 104 to continue performing computations and accessing cache without being interrupted to update the coherence directory 108. Cleaning the coherence directory 108 during the free cycles of the NOC 101 is particularly useful in high-performance computing (HPC) applications where there are periods of computation where the core(s) 103 and/or accelerator(s) 104 are busy, but the NOC 101 is idle. Cleaning the coherence directory 108 without first receiving a request, prompt, or other input from the core(s) 103 and/or accelerator(s) 104 also does not cause any deadlock or livelock in the system 100.

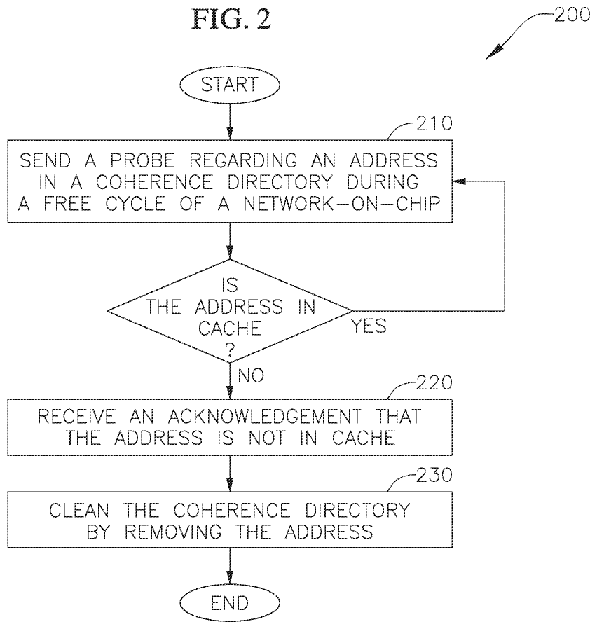

FIG. 2 is a flowchart illustrating tasks of a method 200 of cleaning a coherence directory of a node in a computer system. The node of the computer system includes a network-on-chip (NOC), a number of computing elements (e.g., cores, accelerometers, or a combination of cores and accelerometers) connected to the NOC, and main memory. The computing elements include cached data from the main memory.

In the illustrated embodiment, the method 200 includes a task 210 of sending a command or message (e.g., a probe) during a free cycle of the NOC (i.e., when the NOC is idle) to determine if a particular address in the coherence directory is in any of the caches of the core(s) and/or accelerator(s). The message (e.g., the probe) may be transmitted over an on-node interconnect to the caches of the core(s) and/or the accelerator(s). In one or more embodiments, the probe transmitted in task 210 may be incorporated into any standard coherence protocol (e.g., the MSI protocol, the MESI protocol, the MOSI protocol, or the MOESI protocol) and it may utilize an existing probe/snoop channel.

In the illustrated embodiment, the method 200 includes a task 220 of receiving an acknowledgement indicating whether or not the address transmitted in task 210 is in any of the caches of the core(s) and/or accelerator(s).

In the illustrated embodiment, in response to the acknowledgement of task 220 indicating that the address transmitted in task 210 is not in any of the caches of the cores and/or the accelerators, the method 200 includes a task 230 of cleaning the coherence directory to delete (e.g., scrub) that address entry from the coherence directory.

In this manner, the method 200 involves the coherence directory opportunistically cleaning itself in the background during idle periods of the NOC without receiving a request, prompt, or other input from the core(s) and/or accelerator(s), which enables the core(s) and/or accelerator(s) to continue performing computations and accessing cache without being interrupted to update the coherence directory, which is particularly useful in high-performance computing (HPC) applications where there are periods of computation where the core(s) and/or accelerator(s) are busy, but the NOC is idle. Thus, the method 200 of cleaning the coherence directory does not cause any deadlock or livelock in the computer system.

While this invention has been described in detail with particular references to exemplary embodiments thereof, the exemplary embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims.

What is claimed is:

1. A cache-coherent computer system node comprising:
a network-on-chip;
a plurality of computing elements connected in a fully cache-coherent manner in communication with the network-on-chip;
a coherence directory comprising a plurality of addresses for cache of the plurality of computing elements, a plurality of coherence states of the plurality of addresses, and a plurality of tracking vectors of the plurality of addresses; and
a coherence directory controller configured to send a probe to the plurality of computing elements during a free cycle of the network-on-chip,
wherein the probe is configured to inquire whether an address of the plurality of addresses stored in the coherence directory is in the cache of the plurality of computing elements, and
wherein the coherence directory is configured clean the coherence directory to remove the address in response to an acknowledgement indicating that the address is not in the cache.

2. The cache-coherent computer system node of claim 1, wherein the plurality of computing elements is homogenous and comprises a plurality of cores.

3. The cache-coherent computer system node of claim 1, wherein the plurality of computing elements is homogenous and comprises a plurality of accelerators.

4. The cache-coherent computer system node of claim 1, wherein the plurality of computing elements is heterogeneous and comprises a combination of a plurality of cores and a plurality of accelerators.

5. The cache-coherent computer system node of claim 1, wherein the coherence directory controller is configured to send the probe when the plurality of computing elements is busy.

6. The cache-coherent computer system node of claim 1, wherein the coherence directory controller is configured to send the probe not in response to a command from the plurality of computing elements.

7. The cache-coherent computer system node of claim 1, wherein the probe is incorporated into a standard coherence protocol.

8. The cache-coherent computer system node of claim 7, wherein the standard coherence protocol is a MESI protocol.

9. The cache-coherent computer system node of claim 7, wherein the coherence directory controller is configured to send the probe utilizing an existing probe/snoop channel of the standard coherence protocol.

10. The cache-coherent computer system node of claim 1, further comprising main memory connected to the cache.

11. The cache-coherent computer system node of claim 1, further comprising an interconnect, and wherein the coherence directory controller is configured to send the probe over the interconnect.

12. The cache-coherence computer system node of claim 1, wherein the coherence directory controller is configured to send the probe intermittently.

13. A method of cleaning a coherence directory in a node of a computer system comprising a network-on-chip and a plurality of cores and/or a plurality of accelerators connected to the network-on-chip, the method comprising:
sending, from a coherence directory controller, a probe to cache of the plurality of cores and/or the plurality of accelerators during a free cycle of the network-on-chip, the probe inquiring whether an address stored in the coherence directory is in the cache;
receiving an acknowledgement in response to the probe; and
cleaning the address from the coherence directory in response to the acknowledgement indicating that the address is not in the cache.

14. The method of claim 13, wherein the plurality of cores and/or the plurality of accelerators are busy during the sending of the probe.

15. The method of claim 13, wherein the sending of the probe is not in response to a command from the plurality of cores and/or the plurality of accelerators.

16. The method of claim 13, wherein the probe is incorporated into a standard coherence protocol.

17. The method of claim 16, wherein the standard coherence protocol is a MESI protocol.

18. The method of claim 16, wherein the sending of the probe utilizes an existing probe/snoop channel of the standard coherence protocol.

19. The method of claim 13, wherein the sending the probe comprises sending the probe over an interconnect.

20. The method of claim 13, wherein the sending the probe comprises sending the probe intermittently.
